(19) United States
(12) Patent Application Publication
(10) Pub. No.: US 2023/0177368 A1
(43) Pub. Date: Jun. 8, 2023

(54) INTEGRATED AI PLANNERS AND RL AGENTS THROUGH AI PLANNING ANNOTATION IN RL

(71) Applicant: INTERNATIONAL BUSINESS MACHINES CORPORATION, Armonk, NY (US)

(72) Inventors: Junkyu Lee, San Diego, CA (US); Michael Katz, Goldens Bridge, NY (US); Shirin Sohrabi Araghi, Briarcliff manor, NY (US); Don Joven Ravoy Agravante, Tokyo (JP); Miao Liu, Ossining, NY (US); Tamir Klinger, Brooklyn, NY (US); Murray Scott Campbell, Yorktown Heights, NY (US)

(21) Appl. No.: 17/546,022

(22) Filed: Dec. 8, 2021

(51) Int. Cl. G06N 7/00; G06K 9/62

(52) U.S. Cl. CPC G06N 7/005; G06K 9/6262

(57) ABSTRACT

A computer-implemented method of integrating an Artificial Intelligence (AI) planner and a reinforcement learning (RL) agent through AI planning annotation in RL (PaRL) includes identifying an RL problem. A description received of a Markov decision process (MDP) having a plurality of states in an RL environment is used to generate an RL task to solve the RL problem. An AI planning model described in a planning language is received, and mapping state spaces from the MDP states in the RL environment to AI planning states of the AI planning model is performed. The RL task is generated with an AI planning task from the mapping to generate a PaRL task.

### STATEMENT REGARDING PRIOR DISCLOSURES BY THE INVENTOR OR A JOINT INVENTOR

Lee, Junkyu et al., “AI Planning Annotation in Reinforcement Learning: Options and Beyond,” Aug. 5, 2021, available at:

https://people.csail.mit.edu/tommi/papers/YCZJ_EMNLP2019.pdf

### BACKGROUND

### Technical Field

The present disclosure generally relates to sequential decision-making problems, and more particularly, to sequential decision-making problems utilizing Artificial Intelligence (AI) planning and reinforcement learning (RL).

### Description of the Related Art

AI planning and RL are two methods that can be used to solve sequential decision-making problems. However, AI planning and RL have fundamentally different approaches in operation.

### SUMMARY

In one embodiment, a computer-implemented method of integrating an Artificial Intelligence (AI) planner and a reinforcement learning (RL) agent through AI planning annotation in RL (PaRL) includes identifying an RL problem. A description received of a Markov decision process (MDP) having a plurality of states in an RL environment is used to generate an RL task to solve the RL problem. An AI planning model described in a planning language is received, and mapping state spaces from the MDP states in the RL environment to AI planning states of the AI planning model is performed. The RL task is generated with an AI planning task from the mapping to generate a PaRL task.

In an embodiment, the identified RL problem is solved using the generated PaRL task.

In an embodiment, the PaRL task is formulated by an options framework for the MDP.

In an embodiment, one or more sets of AI plans are generated in the options framework. Options are selected from the options framework for training the RL agent by ranking the options with scores, and the selected options are sent to the RL agent.

In an embodiment, the selecting of options from the options framework is performed offline or online.

In an embodiment, the performing of a rollout option sequence with online planning includes generating a plan given trajectory, ranking options according to a scoring function, and sending the options with a highest score to the RL agent.

In an embodiment, the sending of the options to the RL agent includes guiding a sampling process by a PaRL planner to sample the options.

In an embodiment, the annotating of the RL task with the AI planning task from the mapping to generate the PaRL task includes at least one mapping selected from the group of abstraction mapping in AI planning, heuristic mapping between state spaces, and rule-based mapping.

In an embodiment, the receiving of the AI model described in the planning language is selected from the group of a Planning Domain Definition Language (PDDL), a Stanford Research Institute Problem Solver (STRIPS), a Statistical Analysis Software (SAS+), and an Action Description Language (ADL).

In an embodiment, a computer-implemented method includes producing a policy function and a probability distribution over RL environment actions per RL environment state. The policy function is produced by defining options for the RL environment based on the operators in the planning task. An initiation set of an option is defined by a set of states of the RL environment that is mapped by L to states satisfying the precondition of an action operator, and the termination set of an option is defined by the set of states of the RL environments that are mapped by L to states satisfying the effects of the action operator.

In an embodiment, the computer-implemented method includes generating a sequence of options using an AI planner from a state of the RL environment. The initial state of the planning task is obtained by mapping with L from the RL environment state. Planning algorithms are applied to generate a sequence of action operators that lead from an initial planning state to a planning goal.

In an embodiment, the producing of the policy function and the probability distribution over options per the RL environment state is performed by using a reinforcement learning algorithm.

In an embodiment, the policy function includes a set of option policy functions.

In one embodiment, a computing device configured to integrate an Artificial Intelligence (AI) planner and a reinforcement learning (RL) agent through AI planning annotation in RL (PaRL), the device includes a processor, and a memory coupled to the processor. The memory stores instructions to cause the processor to perform acts including identifying an RL problem; receiving a description of a Markov decision process (MDP) having a plurality of states in an RL environment to generate an RL task to solve the RL problem; receiving an AI planning model described in a planning language; mapping state spaces from the MDP states in the RL environment to AI planning states of the AI planning model; and annotating the RL task with an AI planning task from the mapping to generate a PaRL task.

In one embodiment, a non-transitory computer readable storage medium tangibly embodying a computer readable program code having computer readable instructions that, when executed, causes a computer device to carry out a method of integrating an Artificial Intelligence (AI) planner and a reinforcement learning (RL) agent through AI planning annotation in RL (PaRL). The method includes identifying an RL problem. A description is received of a Markov decision process (MDP) having a plurality of states in an RL environment to generate an RL task to solve the RL problem. An AI planning model described in a planning language is received. State spaces are mapped from the MDP states in the RL environment to AI planning states of the AI planning model, and the RL task is annotated with an AI planning task from the mapping to generate a PaRL task.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition to or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 depicts an overview of integrating artificial intelligence planning in reinforcement learning, consistent with an illustrative embodiment.

FIG. 2 is a flow diagram of a planning annotated reinforcement learning task, consistent with an illustrative embodiment.

FIG. 3 is an illustration of planning an annotated reinforcement learning task, consistent with an illustrative embodiment.

FIG. 4 illustrates formulating an options framework from a PaRL task, consistent with an illustrative embodiment.

FIG. 5 illustrates solving a PaRL task in offline planning, consistent with an illustrative embodiment.

FIG. 6 illustrates an example of mapping planning operators to reinforcement learning options, consistent with an illustrative embodiment.

FIG. 7 illustrates a mapping of planning operators to reinforcement learning options with fixed initial and goal states in Markov Decision Process, consistent with an illustrative embodiment.

FIG. 8 illustrates an example of solving a PaRL in offline mode, consistent with an illustrative embodiment

FIG. 9 illustrates solving a PaRL in offline mode with a ranking function, consistent with an illustrative embodiment.

FIG. 10 illustrates an example of solving a PaRL in an offline mode, consistent with an illustrative embodiment.

FIG. 11 illustrates an example of solving PARL in an online mode with option costs, consistent with an illustrative embodiment.

FIG. 12 illustrates intrinsic rewards for training plan options consistent with an illustrative embodiment.

FIG. 13 illustrates solving a PaRL in offline mode, consistent with an illustrative embodiment.

FIG. 14 is a functional block diagram illustration of a computer hardware platform, consistent with an illustrative embodiment.

FIG. 15 depicts an illustrative cloud computing environment, consistent with an illustrative embodiment.

FIG. 16 depicts a set of functional abstraction layers provided by a cloud computing environment, consistent with an illustrative embodiment.

### DETAILED DESCRIPTION

### Overview

In the following detailed description, numerous specific details are set forth by way of examples to provide a thorough understanding of the relevant teachings. However, it should be understood that the present teachings may be practiced without such details. In other instances, well-known methods, procedures, components, and/or circuitry have been described at a relatively high level, without detail, to avoid unnecessarily obscuring aspects of the present teachings.

As used herein, the term “RL problem” generally refers to a request for a best course of action to be taken given an RL agent's observation of the environment. The best course of action to an RL problem is to find/select a policy that maps a given observation to one or more of the actions to be performed. The course of action is undertaken to maximize a reward, which may be a cumulative reward. An RL task is often defined in terms of a Markov Decision Process (MDP) in the RL environment.

It is to be understood that any reference to Q-Learning does not limit the appended claims, and other reinforcement learning algorithms and policy optimization algorithms are applicable.

AI planning tasks are used to define high-level decision problems and reformulate an original “flat” RL problem via an options framework. Through the use of AI planning operators, the RL options are defined. The RL problem is annotated with an AI planning task(s). The RL problem can be reformulated as a Hierarchical RL problem.

With regard to integrating AI planners and RL agents through AI planning annotation in RL, it is to be understood that AI planning provides solutions to shortest path problems in large-scale state transition systems concisely declared by symbolic languages. As a result, AI planning is capable of quickly solving large tasks. For example, AI planning uses operator models and also provides efficient plan generation. On the other hand, RL does not require an operator model and learns a policy to guide an agent to high reward states. However, RL uses a large number of training examples to learn a policy. RL primarily addresses discounted Markov Decision Process (MDP) problems in a model-free setting. RL can be combined with deep neural networks (Deep RL) to solve problems with large-scale unstructured state spaces. While Deep RL (DRL) solves problems with large-scale unstructured state spaces, a model-free DRL operation can be sample inefficient when the reward is sparse, or in a case where the underlying model has dead ends or zero-length cycles.

As discussed herein, embodiments of the present disclosure teach a computer-implemented method and system of integrating AI planners and RL agents through AI planning annotation in RL (PaRL). PaRL includes an integrated AI planning and RL architecture to perform a Hierarchical Reinforcement Learning (HRL) approach that formulates an RL problem with a complex hierarchy of sequential decision-making problems. AI planning tasks are used to define high-level decision problems and reformulate an original “flat” RL problem via an options framework. PaRL links the state abstraction in AI planning and a temporal extraction in RL. In a case where a state space mapping assumption is common to all RL options can be defined on planning operators. The RL options can be defined through the use of planning tasks, defining a mapping between action spaces, and the use of reinforcement learning algorithms. In an embodiment, the frameworks can form an environment for problem-solving, for example, using Python, TensorFlow, etc. However, the appended claims of the disclosure are not limited to the aforementioned environments.

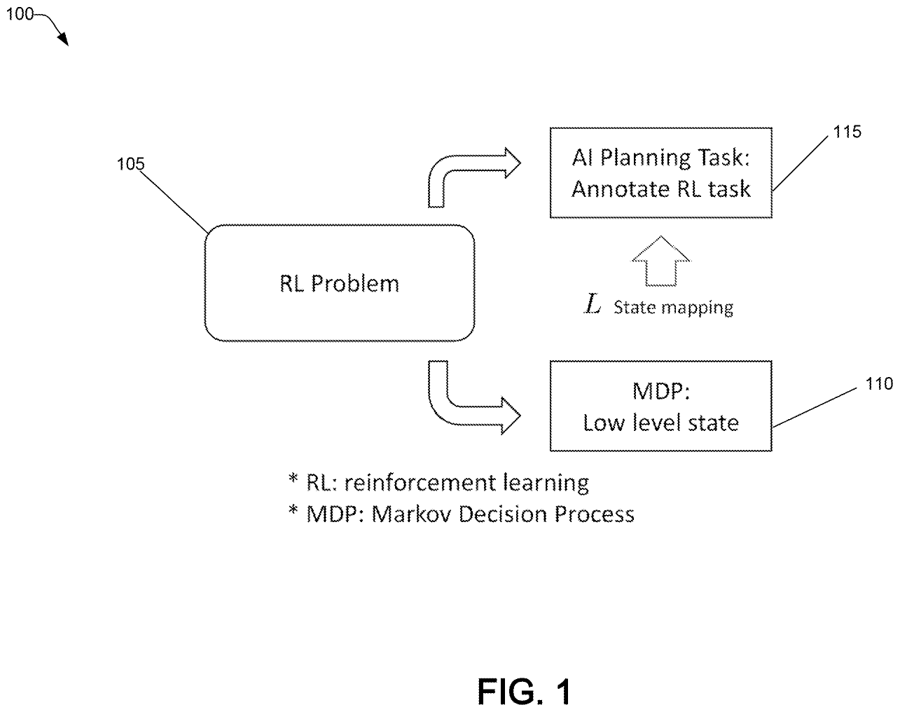

FIG. 1 depicts an overview 100 of a computer-implemented method of integrating AI planning in an RL framework, consistent with an illustrative embodiment. The sequential decision making problems (SDMP) are a mix of low-level control and high-level concepts. The low-level control can include a perception-oriented mode, and unstructured data features. The high-level concepts are suitable for symbolic reasoning.

In an RL framework, a processor is configured to solve an RL problem 105. A description of a Markov Decision Process (MDP) 110 in the RL environment is received/retrieved. A description of a model in one of the planning languages is received. The planning languages include but are not limited to a Planning Domain Definition Language (PDDL), a Stanford Research Institute Problem Solver (STRIPS), Statistical Analysis Software SAS+, Action Description Language (ADL). A mapping L is performed to map from the MDP states of the RL environment to states of the planned model. At 115, the RL task is annotated using the AI planning task.

The embodiments of the computer-implemented method and system and method of the present disclosure provide for an improvement in the field of solving sequential decision-making problems (SDMP) in which the results have increased accuracy over the use of either AI planning or Reinforcement Learning alone. In addition, there is an improvement in computer operations as the computer-implemented method and system according to the present disclosure reduces the amount of processing power used to achieve the results, with reduced storage usage, and the results have increased accuracy. The improved efficiency of operation provides for a reduction in processing to achieve solutions to SDMP, also resulting in a savings of storage and power usage.

Additional advantages of the present architecture are disclosed herein.

### Example Embodiments

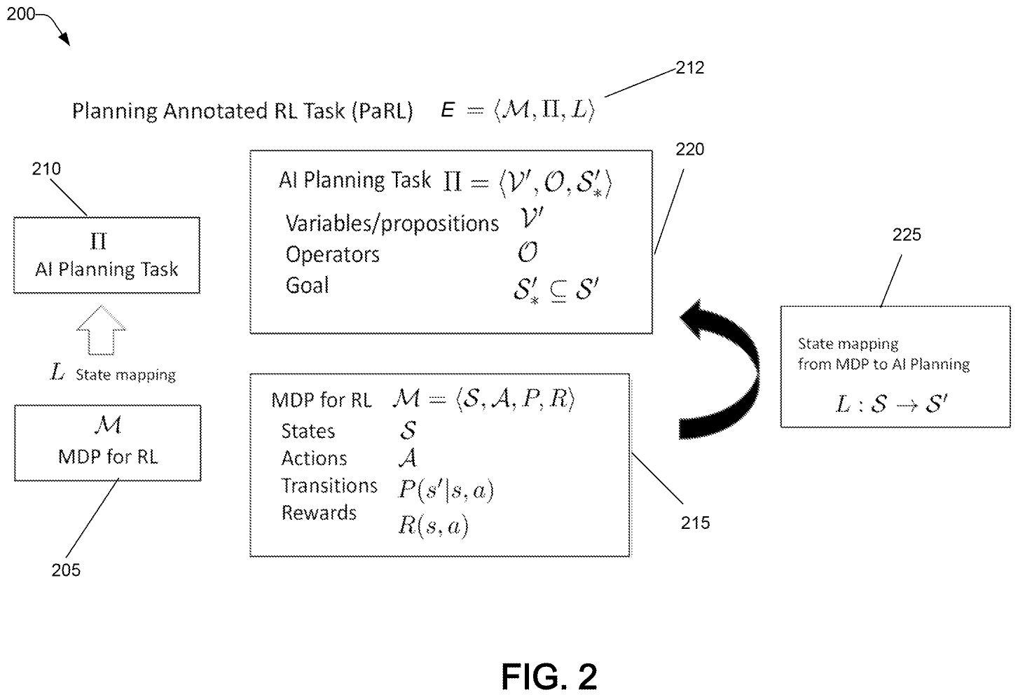

FIG. 2 is a diagram 200 of a planning annotated RL task, consistent with an illustrative embodiment. A hierarchical reinforcement learning (HRL) framework is formulated when given a symbolic description of the underlying MDP. in this embodiment, there is a linking of the AI planning task and the RL MDP task by viewing the AI planning task as an abstraction of the RL MDP task, and mapping each state transition. The frame concept in AI planning is extended to an options framework to characterize the conditions that regulate the MDP task to behave like a given planning task. In a planning annotated RL task, a Markoff Decision Process (MDP) for RL 205 is used to provide an AI Planning Task 210 by L state mapping. The definition of a PaR1 task is used to specify some of the functionality of reinforcement learning in a declarative way.

With continued reference to FIG. 2, the planning annotated RL (PaRL) task 212 is shown as E= [symbol] , Π, L [symbol] , where box 215 shows the MDP for RL 210 as [symbol] = [symbol] S, [symbol] , P, R [symbol] which is defined as a goal-oriented MDP over RL state, with S=states, [symbol] =actions, P(s′|s, a)=transitions, and [symbol] (s, a)=rewards. In addition, box 220 shows the AI planning task 205 defined as Π= [symbol] [symbol] , S_{*}′ [symbol] in which [symbol] ′ are variables/propositions, [symbol] are operators, and S_{*}′⊆S′ is the goal. The state mapping 225 from MDP to AI planning is shown as L: S→S′.

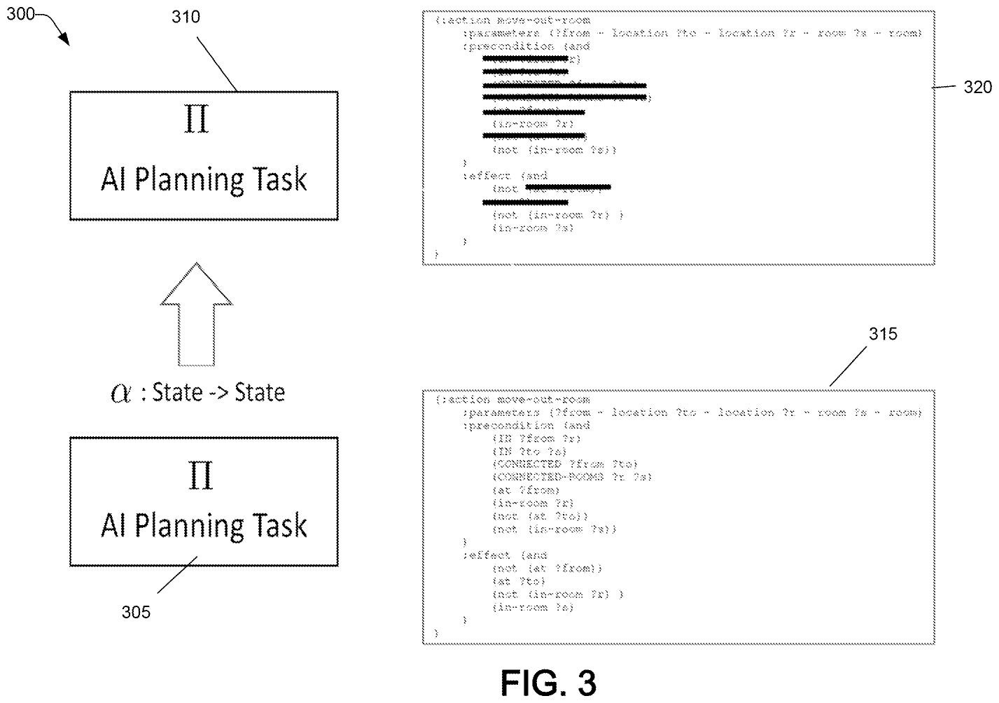

FIG. 3 is an illustration 300 of planning an annotated RL task, consistent with an illustrative embodiment. There can be two levels of representations including an RL level focus on perception-oriented representation and annotating the task structure in symbolic representation. In the RL level focus, inputs accept the data-driven approaches. In the annotating task structure in symbolic representation, RL states are mapped to a planning state. There is also mapping of action operators in AI planning to temporarily extended actions, a.k.a. options in RL. To solve problems having complicated task structures, PaRL defines options for RL, AI planners participate in a sampling process, and an RL algorithm learns from informative samples. Accordingly, in FIG. 3 there is shown an AI planning task 305 that is state-to-state mapped (abstraction mapping) to a resultant AI planning task 310. The symbolic representation 320 of a solution to a real-world problem 315 is then shown with irrelevant details extracted away (represented by the blackened lines). This state abstraction mapping can be performed, because in real-world problems, some commands (such as the “at ?to” shown in 315) are not sufficiently accurate for the planner.

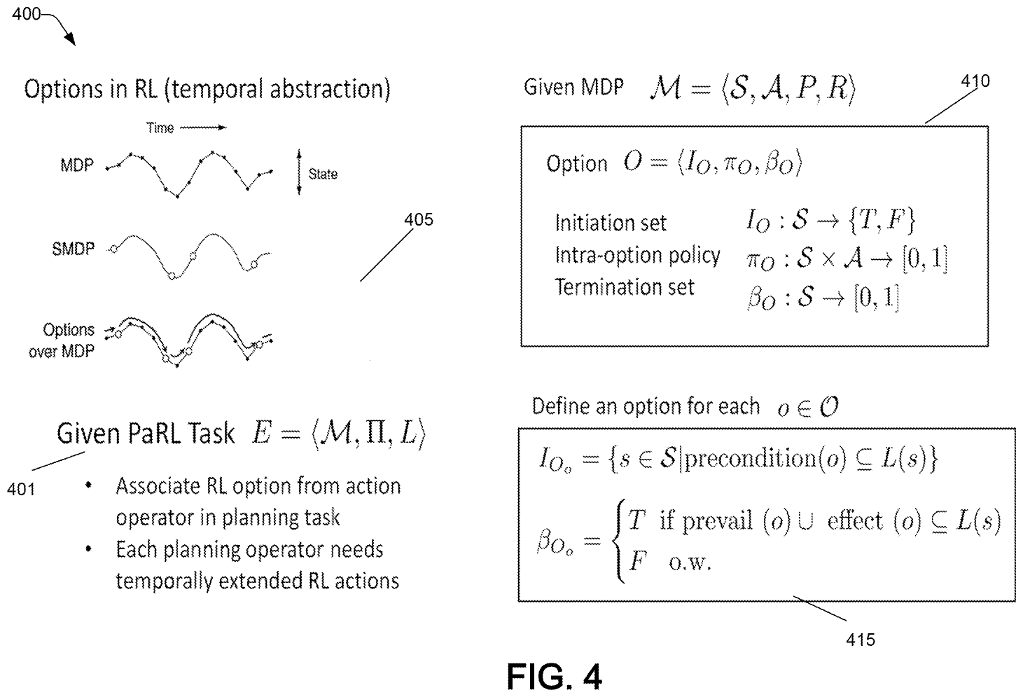

FIG. 4 illustrates formulating an options framework from a PaRL task 400, consistent with an illustrative embodiment. The PaRL task formulates the options framework for an underlying MDP. As shown at 401, for a given PaRL task E= [symbol] , Π, L [symbol] (as discussed above), the actions include associating an RL option from an action operator in a planning task. Each planning operator will utilize temporally extended RL actions. Referring to the Given MDP shown in 410, an option O= [symbol] I_{O}, π_{O}, β_{O} [symbol] with an initiation set I_{O}: S→{T, F} an intra-option policy π_{O}: S× [symbol] →[0, 1], and a termination set β_{O}: S→[0, 1].

As shown in box 415, an option is defined for each oϵ0, where:

$${I}_{{O}_{o}} = \{ s ∈ S \vert precondition ( o ) ⊆ L ( s ) \} ; and$$

$${β}_{{O}_{o}} = \{ \begin{matrix}T & if prevail ( o ) ⋃ effct ( o ) ⊆ L ( s ) \\ F & o . w .\end{matrix}$$

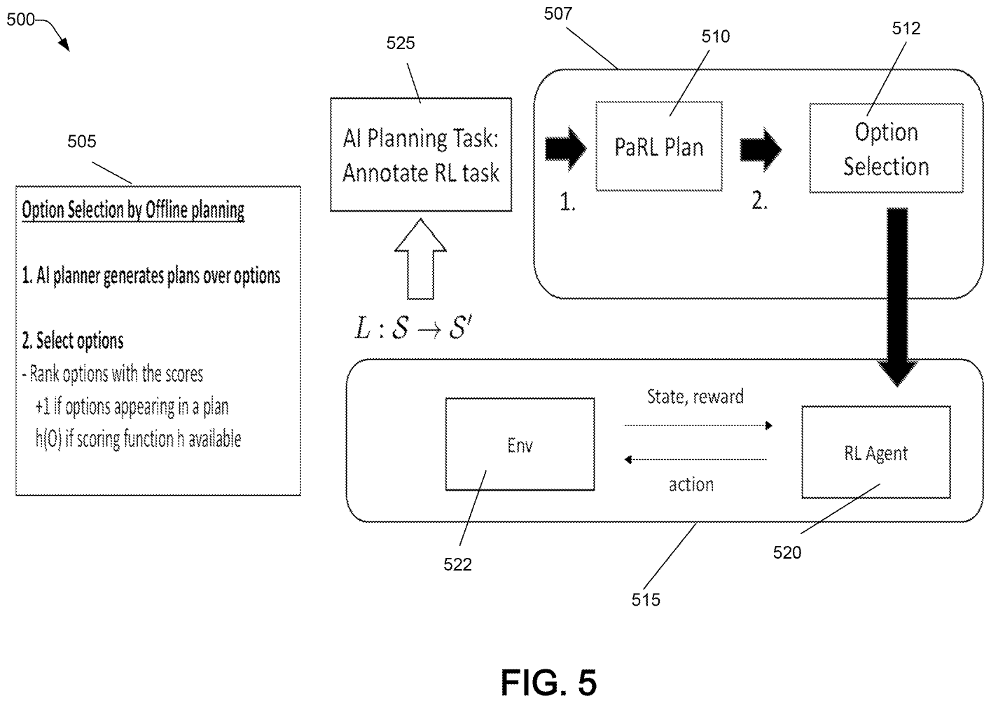

FIG. 5 illustrates solving a PaRL task 500 in offline planning, consistent with an illustrative embodiment. One of the challenges of offline planning is that there are many options available for training and use. However, the only train/use options that should be selected are those that facilitate solving a PaRL problem. As shown at an option selection overview by offline planning summary 505, (1) an AI planner generates plans over options, and (2) options are selected. The options are ranked with scores of +1 if the options appear in a plan h(0) if a scoring function “h” is available. At 507, it is shown a PaRL plan 510 and the option selection 512 are received by an RL agent 515. At 515 the interaction between the RL agent and the environment 522 to train the RL agent 520 to maximize a reward. The RL agents learn from actions the state of the environment 522, and the reward. The RL agent 520 can be trained by receiving observations (e.g., option selections) and choosing actions. The actions can be applied to the environment 522. Conversely, the environment 522 returns the state and the reward. The environment may be implemented in Python®, TensorFlow®, or some other framework. The refined interaction at 515 between the RL agent 520 and the environment 522 is followed by a state-to-state mapping of an AI planning task and an annotated RL task (shown in box 525).

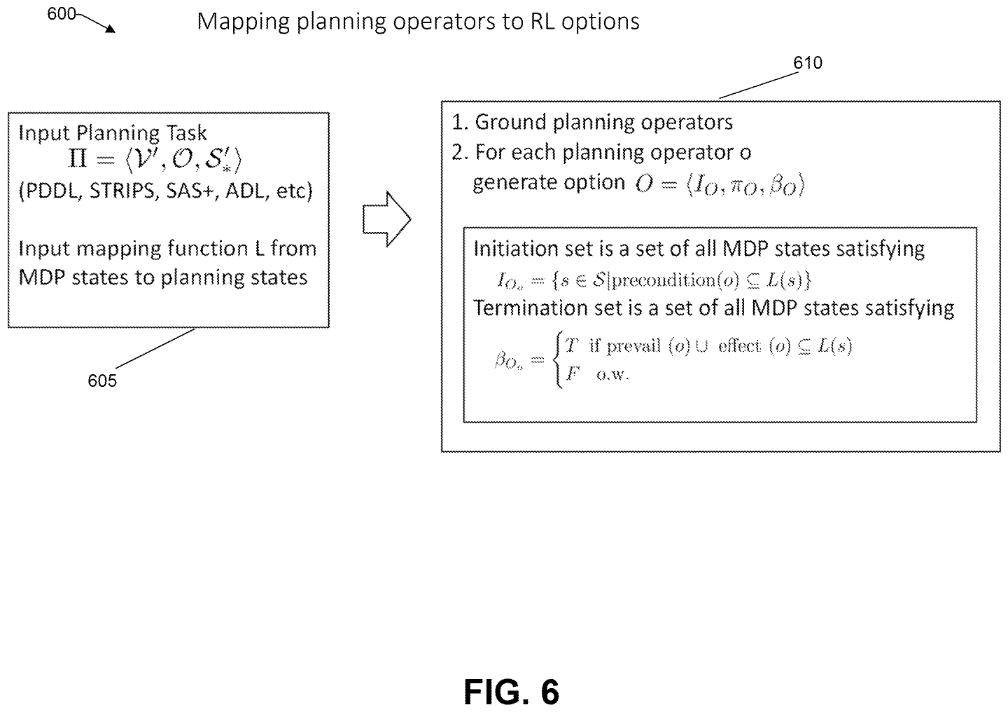

FIG. 6 illustrates an example 600 of mapping planning operators to RL options, consistent with an illustrative embodiment. At 605, the input planning task Π= [symbol] ′, [symbol] , S_{*}′ [symbol] is formed using AI planning techniques such as PDDL, STRIPS, SAS+, ADL, etc. (also discussed herein above). There is an input mapping function L from the MDP states to the planning states. In Π= [symbol] ′, [symbol] , S_{*}′ [symbol] , [symbol] ′ are variables/propositions, [symbol] are operators, and S_{*}′⊆S′ is the goal. At 610, there are ground planning operators used to generate an option [symbol] = [symbol] I_{O}, π_{O}, β_{O} [symbol] with an initiation set of all MDP states satisfying I_{O}_{ₒ}={s∈S|precondition(o)⊆L(s)} and a termination set of all MDP states satisfying the following:

$${β}_{{O}_{o}} = \{ \begin{matrix}T & if prevail ( o ) ⋃ effct ( o ) ⊆ L ( s ) \\ F & o . w .\end{matrix} .$$

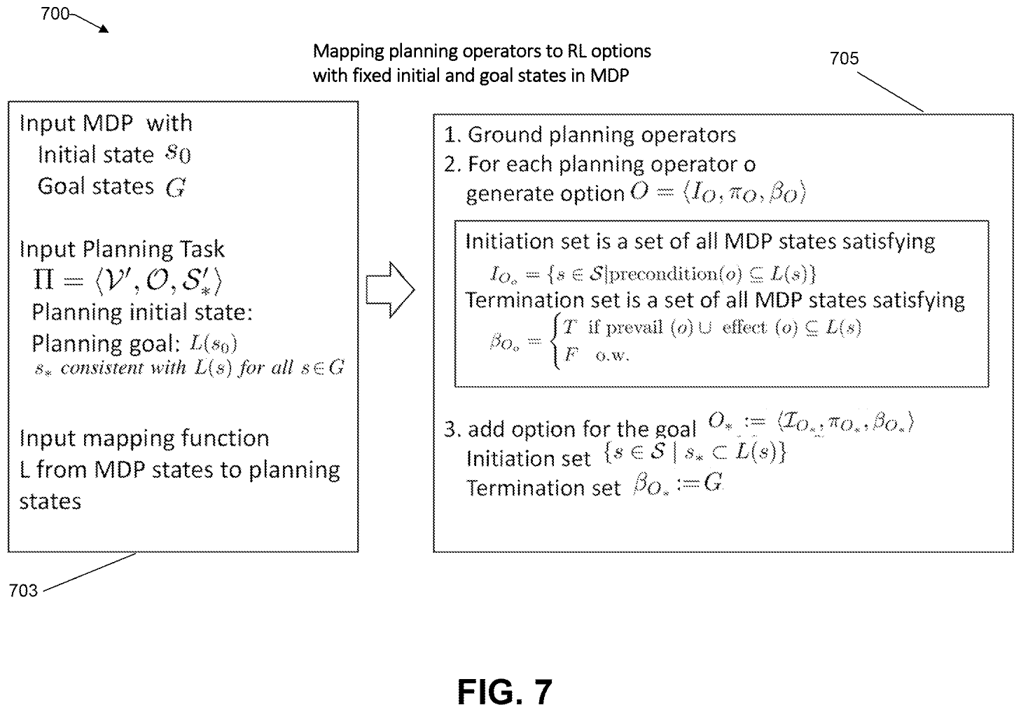

FIG. 7 illustrates the mapping of planning operators to RL options 700 with fixed initial and goal states in MDP, consistent with an illustrative embodiment. FIG. 7 is somewhat similar in part to what is shown in FIG. 6, but as shown in 703 the input MDP has an initial state s₀ and a goal state G. With regard to the input planning task, there is a planning initial state s₀ with a planning goal L(s₀)s_{*} consistent with L(s) for all s∈G With regard to 705, the first two operations are explained with regard to FIG. 6 at box 610. However, there is a third operation to add an option for the goal O_{*}:= [symbol] _{O}_{_{*}}, π_{O}_{_{*}}, β_{O}_{_{*}} [symbol] , with an initiation set {s∈S|s_{*}⊂L(s)}, and a termination set β_{O}_{_{*}}:=G.

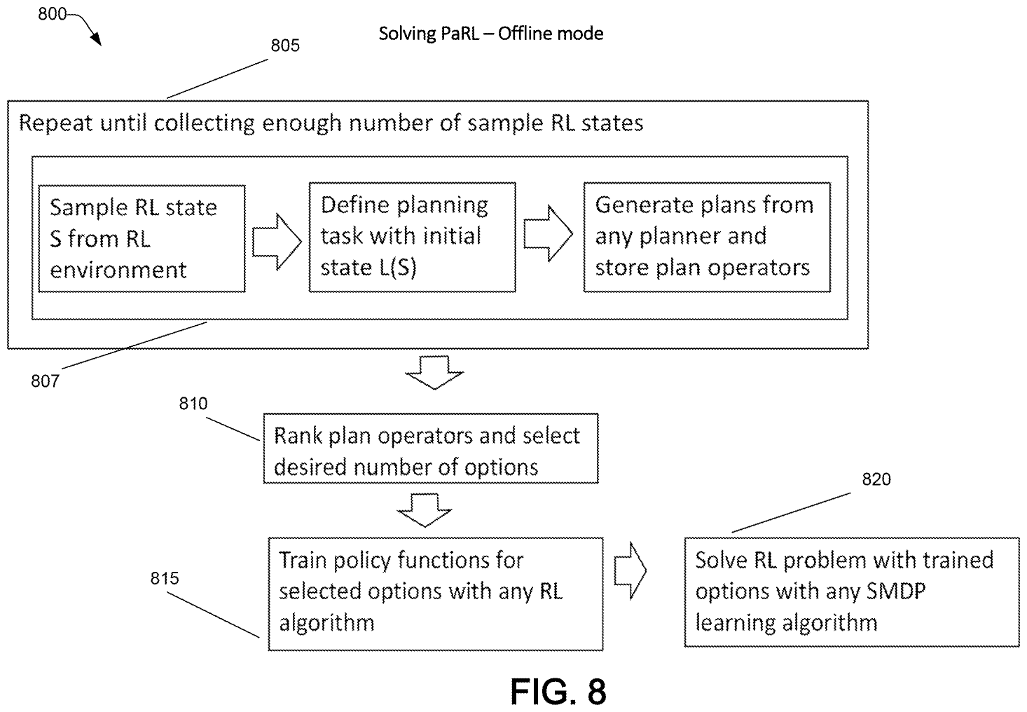

FIG. 8 illustrates an example of solving a PaRL in offline mode 800, consistent with an illustrative embodiment. At operation 805, the operation of collecting sample RL sample states is repeated until a threshold that a sufficient number has been collected. The threshold can be, for example 10⁶ to 10⁷ samples. Conceptually this collection of samples can continue until the RL algorithms stop when the parameters are not changing anymore because of the convergence. Practically, there is a limitation regarding the time to obtain a solution, which can be 10⁶ to 10⁹ samples depending on the problem and implementation. Typically, a range would not be less than 10³ or more than 10¹². At 807, it is shown the operations include sampling the RL “S” from the RL environment, defining planning with initial states L(S), and generating plans from any planner and store plan operators. At 810, plan operators are ranked and a desired number of options are selected. The plan operators may be ranked in terms of reward. At 815, there is a training operation for policy functions of selected options with any RL algorithm. A non-exhaustive example of such an RL algorithm is a Proximal Policy Optimization (PPO) algorithm. Then at 820, the RL problem is solved with trained options of any semi-Markoff Decision Process (SMDP) learning algorithm. Some non-exhaustive examples of some well-known SMDP learning algorithm include SMDP Q-learning, and Intra-option Q-learning.

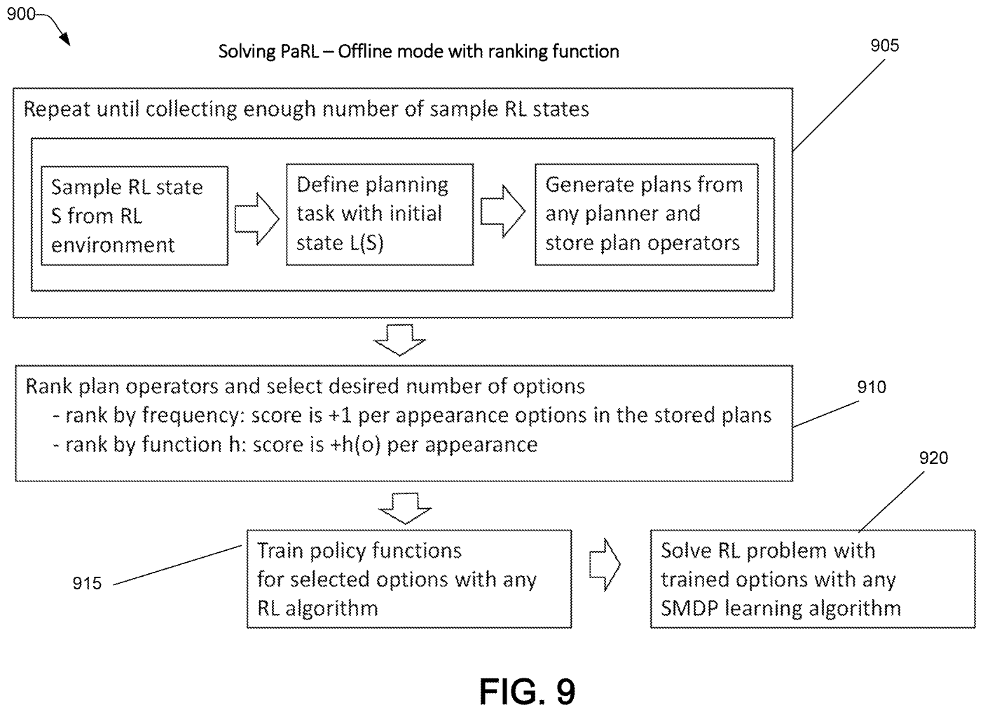

FIG. 9 illustrates solving a PaRL in offline mode 900 with a ranking function, consistent with an illustrative embodiment. Operation 905 is similar to the operation 805 in FIG. 8. In addition, operation 915 and 920 are similar to the operations shown and described with regard to operations 815 and 820. One way that the operation in FIG. 9 differs is from FIG. 8 is in the ranking of the plan operators and the select desired number of options 910. There is shown a rank by frequency, where the score is +1 per appearance options in the stored plans. There is also shown a rank by function h, where the score is +h(o) per appearance.

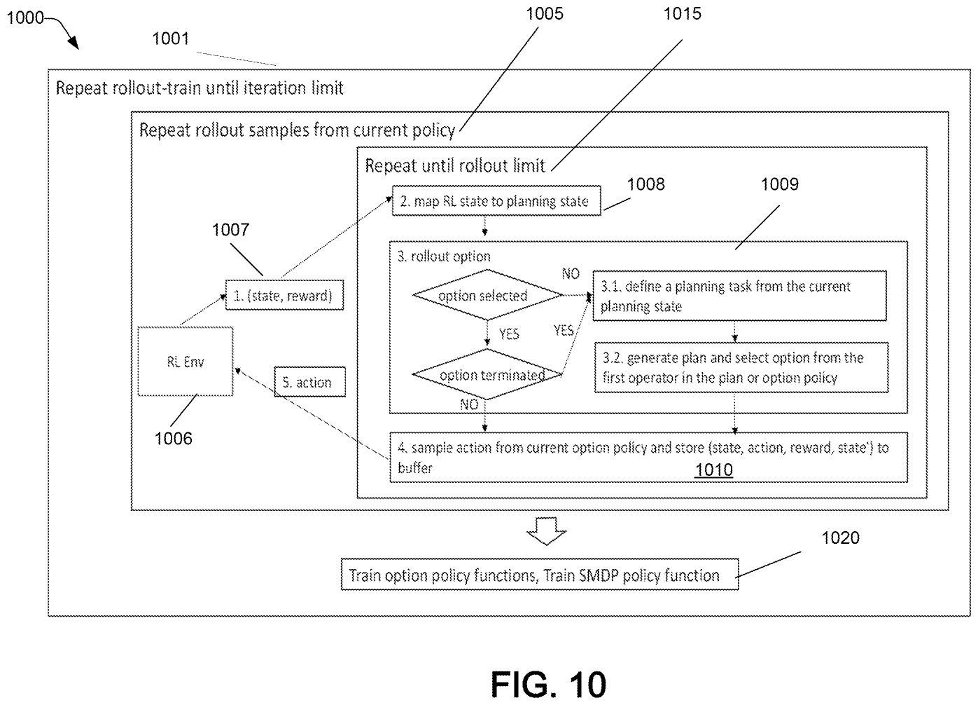

FIG. 10 illustrates an example of solving PaRL in an offline mode 1000, consistent with an illustrative embodiment. The selecting of options from the options framework in the present disclosure can be performed either offline or online. In an offline operation, a planner generate plans and selects options from those actions appearing in the plans. In an online operation, a planner generates a plan while an agent is interacting with an RL environment.

There is shown a repeat rollout-train until iteration limit 1001, and repeat rollout samples from a current policy 1005, which includes a repeat until rollout limit 1015. When the iteration loop begins at 1015, there's no option selected, leading to a process of generating a plan from a planning task, and choosing an option from the action operator in the plan. There is shown an RL environment 1006, in which at 1007 a reward and a state are received. At 1008, the RL state is mapped to a planning state. At 1009, a rollout option includes determining if an option is selected. If no option is selected, a planning task is defined from the current planning state, followed by generating a plan and selecting an option from the first operator in the plan or option policy.

At 1010, an action is sampled from the current policy option and stored in a buffer. At 1010, samples are generated using the selected option policy and leading to the next RL state. In the following iteration, there is an option selected, and if so, there is a check to determine whether the current option needs to be terminated by checking the termination condition, leading to selecting a new option (Yes), or continuing with the current option (No). These actions repeat in 1005 until a rollout limit is reached. The rollout limit is application dependent, and reflects the longest trajectory that the algorithm seeks to generate from the environment. Typically, a limit is larger than a length of the desired trajectory connecting the initial state to a desired goal state. A non-exhaustive example of a limit can be 1000 steps for a certain application. Finally, the option policy functions are trained, as is the SMDP policy function.

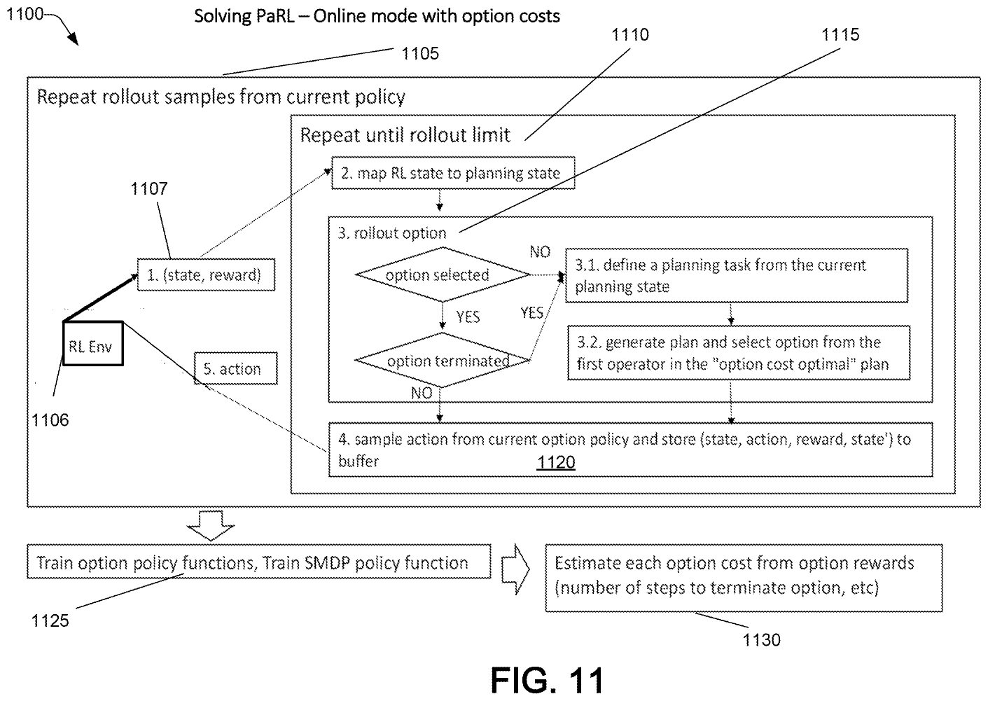

FIG. 11 illustrates an example of solving PaRL in an online mode 1100 with option costs, consistent with an illustrative embodiment. The operations of repeat rollout samples from the current policy 1105 are similar to the discussion of the operations of the current policy 1005 in FIG. 10. At 1106, the RL environment interacts with the state reward 1107 of an agent as in FIG. 10. At 1110, there is a repeated until a rollout limit. At 1115, the rollout option is in FIG. 10 except that at 3.2 the operation is “generate plan and selection option from the first operator in the “option cost-optimal” plan (the words in quotes being new). At 1120, the operation of sampling an action from a current policy option and store 1120 is similar to 1010 of FIG. 10. At operation 1125, there is a training option policy function, train the SMDP policy function. At 1130, each option cost is estimated from option reward (the number of steps to terminate option, etc.).

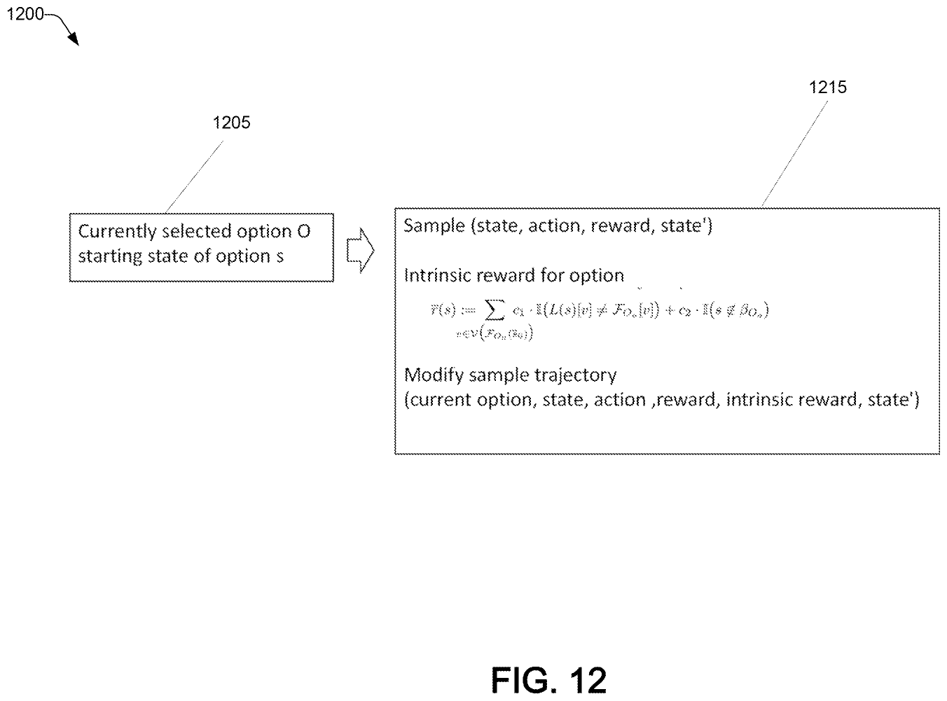

FIG. 12 illustrates providing intrinsic rewards for training plan options 1200 consistent with an illustrative embodiment. Upon generating a (state, action, reward, state’) trajectory to train policy functions in offline and online mode, additional intrinsic rewards are derived for option training. At 1205, there is shown a current selection option O starting state of option “s”. At 1215, there is performed a sample of (state, action, reward, state’). An intrinsic reward for an option is identified using the formula:

$$\overline{r} ( s ) := \sum c \cdot 𝕀 ( L ( s ) [ v ] \neq {ℱ}_{{O}_{o}} [ v ] ) + {c}_{2} \cdot 𝕀 ( s ∉ {β}_{{O}_{o}} )$$

$$v ∈ 𝒱 ( {ℱ}_{{O}_{o}} ( {\overline{s}}_{0} ) )$$

wherein H is an indicator function, and c₁, c₂ are negative costs. The variables are the variables in the planning task, where a planning task is defined as a set of variables, a set of operators over the variables, and the goal in FIG. 2.

A sample trajectory is then modified (current option, state, action, reward, intrinsic reward, state’). Planning annotation with an intrinsic reward increases the sample efficiency of PaRL as compared with a flat RL case.

### Example Process

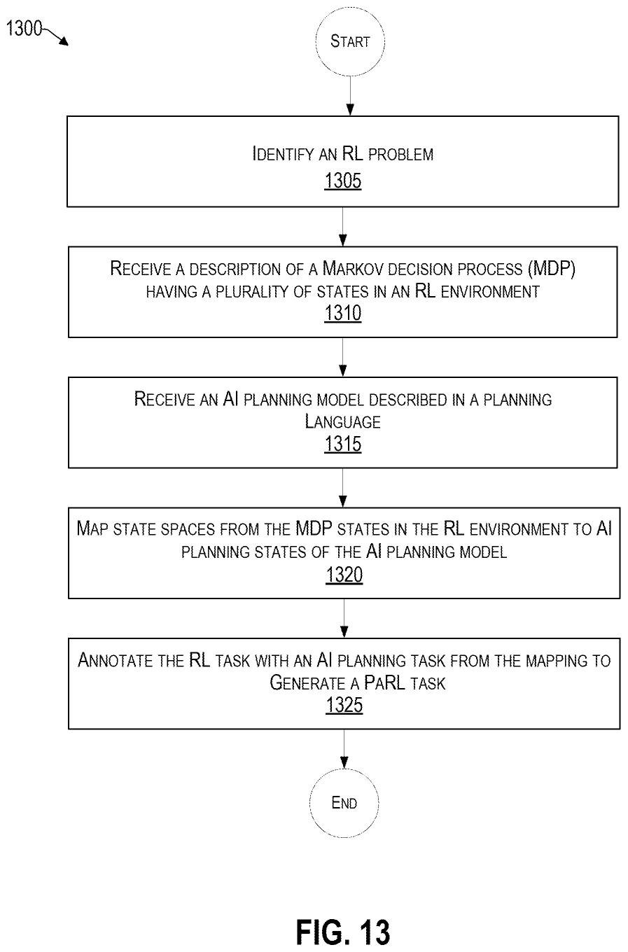

With the foregoing overview of the example architecture, it may be helpful now to consider a high-level discussion of an example process. To that end, FIG. 13 is a flowchart of a computer-implemented method of reinforcement learning (RL) through Artificial Intelligence (AI) planning annotation, consistent with an illustrative embodiment. FIG. 13 is shown as a collection of blocks, in a logical order, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform functions or implement abstract data types. In each process, the order in which the operations are described is not intended to be construed as a limitation, and any number of the described blocks can be combined in any order and/or performed in parallel to implement the process.

At operation 1305, an RL problem is identified. For example, the RL problem may have been formulated in terms of an environment is defined (agents, states, actions and rewards). Data collection, feature engineering, and a modeling is part of the formulation.

At operation 1310, a description is received of a Markov Decision Process (MDP) in an RL environment. The MDP description is used to generate a task to solve the RL problem.

At operation 1315, an AI planning model is received. The AI planning model is described in a planning language. A non-exhaustive example of some of the planning languages for the model are PDDL, STRIPS, SAS+, ADL.

At operation 1320, state spaces are mapped from the MDP states in the RL environment to AI planning states of the received AI planning model. Abstraction mapping, heuristic mapping between state spaces, and rule-based mapping of the MDP states to the AI planning states.

At operation 1325, the RL task is annotated with an AI planning task from the mapping to generate a PaRL task. The tasks are annotated by symbolic planning. The identified RL problem can then be solved using the PaRL task.

### Example Particularly Configured Computer Hardware Platform

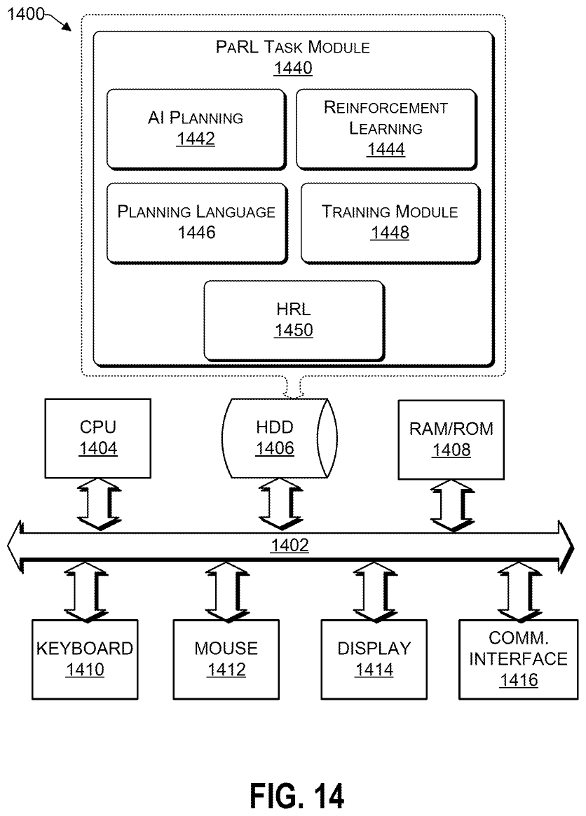

FIG. 14 provides a functional block diagram illustration 1400 of a computer hardware platform. In particular, FIG. 14 illustrates a particularly configured network or host computer platform 1400, as may be used to implement the methods shown in FIG. 13

The computer platform 1400 may include a central processing unit (CPU) 1404, a hard disk drive (HDD) 1406, random access memory (RAM) and/or read-only memory (ROM) 1408, a keyboard 1410, a mouse 1412, a display 1414, and a communication interface 1416, which are connected to a system bus 1402. The HDD 1406 can include data stores.

In one embodiment, the HDD 1406 has capabilities that include storing a program that can execute various processes, such as machine learning, predictive modeling, classification, updating model parameters. The ML model generation module 1440 is configured to generate a machine learning model based on at least one of the generated candidate machine learning pipelines.

With continued reference to FIG. 14, there are various modules shown as discrete components for ease of explanation. However, it is to be understood that the functionality of such modules and the quantity of the modules may be fewer or greater than shown. A Planning annotated Reinforcement Learning (PaRL) task module 1440 is configured to generate AI planning RL tasks that link an AI planning task model and an RL MDP task model through mapping to annotate the RL MDP task model. An AI planning module 1442 is configured to generate an AI planning task model used to provide an annotated PaRL task. A Reinforcement Learning (RL) module 1444 is configured to generate the RL model. A planning language module 1446 is configured to describe a model in a planning language including but not limited to PDDL, STRIPS, ADL+. A training module 1448 is configured to train an RL model to regulate an option learning agent to restrict exploration with the state space relevant to the planning task. A hierarchical reinforcement learning module 1450 is configured to execute HRL algorithms for solving PaRL tasks.

### Example Cloud Platform

As discussed above, functions relating to prescriptive may include a cloud. It is to be understood that although this disclosure includes a detailed description of cloud computing as discussed herein below, the implementation of the teachings recited herein is not limited to a cloud computing environment. Rather, embodiments of the present disclosure are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

### Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

### Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

### Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

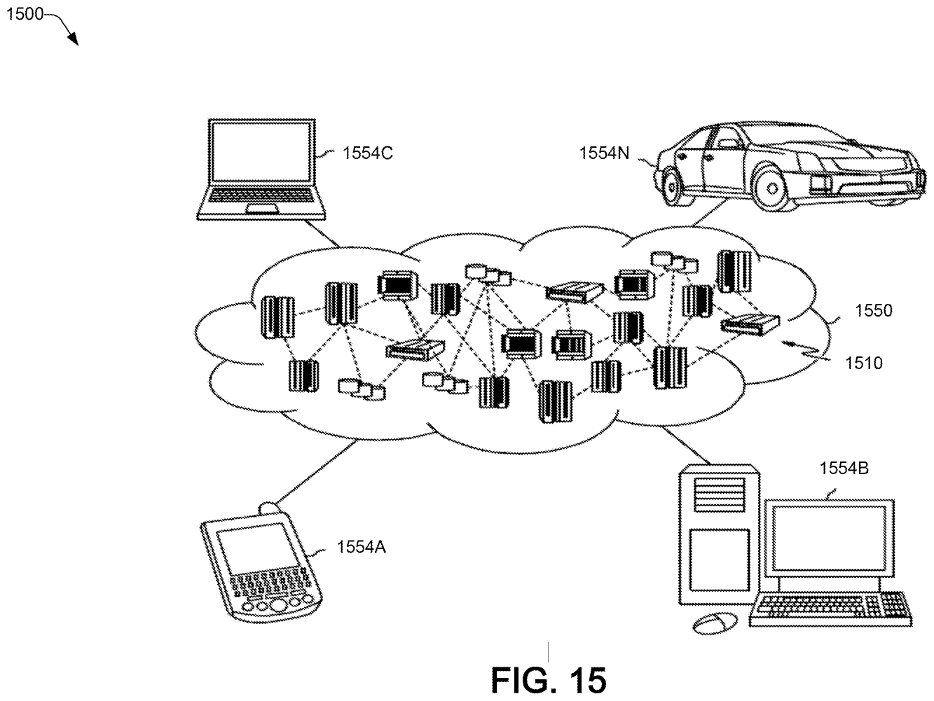

Referring now to FIG. 15, an illustrative cloud computing environment 800 utilizing cloud computing is depicted. As shown, cloud computing environment 800 includes cloud 850 having one or more cloud computing nodes 1510 with which local computing devices used by cloud consumers, such as, for example, personal digital assistant (PDA) or cellular telephone 1554A, desktop computer 1554B, laptop computer 1554C, and/or automobile computer system 1554N may communicate. Nodes 1510 may communicate with one another. They may be grouped (not shown) physically or virtually, in one or more networks, such as Private, Community, Public, or Hybrid clouds as described hereinabove, or a combination thereof. This allows cloud computing environment 1500 to offer infrastructure, platforms, and/or software as services for which a cloud consumer does not need to maintain resources on a local computing device. It is understood that the types of computing devices 1554A-N shown in FIG. 15 are intended to be illustrative only and that computing nodes 1510 and cloud computing environment 800 can communicate with any type of computerized device over any type of network and/or network addressable connection (e.g., using a web browser).

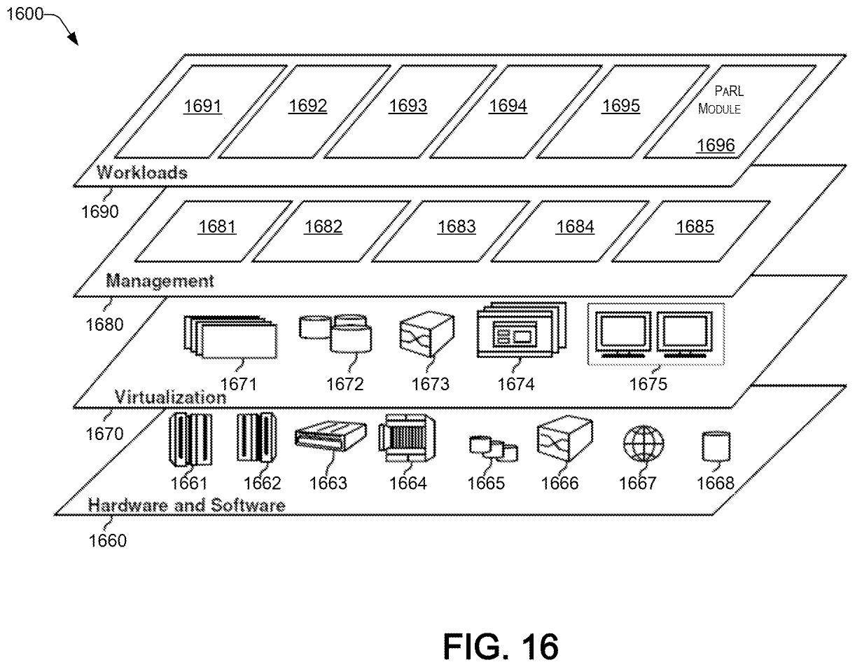

Referring now to FIG. 16, a set of functional abstraction layers 1600 provided by cloud computing environment 1500 (FIG. 15) is shown. It should be understood in advance that the components, layers, and functions shown in FIG. 16 are intended to be illustrative only and embodiments of the disclosure are not limited thereto. As depicted, the following layers and corresponding functions are provided:

Hardware and software layer 1660 include hardware and software components. Examples of hardware components include: mainframes 1661; RISC (Reduced Instruction Set Computer) architecture-based servers 1662; servers 1663; blade servers 1664; storage devices 1665; and networks and networking components 1666. In some embodiments, software components include network application server software 1667 and database software 1668.

Virtualization layer 1670 provides an abstraction layer from which the following examples of virtual entities may be provided: virtual servers 1671; virtual storage 1672; virtual networks 1673, including virtual private networks; virtual applications and operating systems 1674; and virtual clients 1675.

In one example, management layer 1680 may provide the functions described below. Resource provisioning 1681 provides dynamic procurement of computing resources and other resources that are utilized to perform tasks within the cloud computing environment. Metering and Pricing 1682 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 1683 provides access to the cloud computing environment for consumers and system administrators. Service level management 1684 provides cloud computing resource allocation and management such that required service levels are met. Service Level Agreement (SLA) planning and fulfillment 1685 provide pre-arrangement for, and procurement of, cloud computing resources for which a future requirement is anticipated in accordance with an SLA.

Workloads layer 1690 provides examples of functionality for which the cloud computing environment may be utilized. Examples of workloads and functions which may be provided from this layer include: mapping and navigation 1691; software development and lifecycle management 992; virtual classroom education delivery 1693; data analytics processing 1694; transaction processing 1695; a PaRL module 1696 configured to integrate AI planning and RL architecture to perform a Hierarchical Reinforcement Learning (HRL) approach that formulates an RL problem with a complex hierarchy of sequential decision-making problems. AI planning tasks are used to define high-level decision problems and reformulate an original “flat” RL problem via an options framework. PaRL links the state abstraction in AI planning and a temporal extraction in RL, as discussed herein above.

### CONCLUSION

The descriptions of the various embodiments of the present teachings have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, operations, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

The flowchart, and diagrams in the figures herein illustrate the architecture, functionality, and operation of possible implementations according to various embodiments of the present disclosure.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any such actual relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A computer-implemented method of integrating an Artificial Intelligence (AI) planner and a reinforcement learning (RL) agent through AI planning annotation in RL (PaRL), the computer-implemented method comprising:
identifying an RL problem;
receiving a description of a Markov decision process (MDP) having a plurality of states in an RL environment to generate an RL task to solve the RL problem;
receiving an AI planning model described in a planning language;
mapping state spaces from the MDP states in the RL environment to AI planning states of the AI planning model; and
annotating the RL task with an AI planning task from the mapping to generate a PaRL task.

2. The computer-implemented method of claim 1, further comprising solving the identified RL problem using the generated PaRL task.

3. The computer-implemented method of claim 1, further comprising formulating by the PaRL task an options framework for the MDP.

4. The computer-implemented method of claim 3, further comprising:
generating one or more sets of AI plans in the options framework;
selecting options from the options framework for training the RL agent by ranking the options with scores; and
sending the options to the RL agent.

5. The computer-implemented method of claim 4, wherein the selecting options from the options framework is performed online or offline.

6. The computer-implemented method of claim 5, further comprising performing rollout option sequence with online planning by:
generating a plan given trajectory;
ranking options according to a scoring function; and
sending the options with a highest score to the RL agent.

7. The computer-implemented method of claim 6, wherein sending the options to the RL agent further comprises guiding a sampling process by a PaRL planner to sample the options.

8. The computer-implemented method of claim 1, wherein the annotating of the RL task with the AI planning task from the mapping to generate the PaRL task comprises at least one mapping selected from the group of: abstraction mapping in AI planning, heuristic mapping between state spaces, and rule-based mapping.

9. The computer-implemented method of claim 1, wherein the receiving of the AI model described in the planning language is selected from the group of a Planning Domain Definition Language (PDDL), a Stanford Research Institute Problem Solver (STRIPS), a Statistical Analysis Software (SAS+), and an Action Description Language (ADL).

10. The computer-implemented method of claim 1, further comprising producing a policy function and a probability distribution over RL environment actions per RL environment state by:
defining options for the RL environment based on the operators in the planning task;
defining an initiation set of an option by a set of states of the RL environment that is mapped by L to states satisfying the precondition of an action operator; and
defining the termination set of an option by the set of states of the RL environments that are mapped by L to states satisfying the effects of the action operator.

11. The computer-implemented method of claim 10, further comprising:
generating a sequence of options using an AI planner from a state of the RL environment;
obtaining the initial state of the planning task by mapping with L from the RL environment state; and
applying planning algorithms to generate a sequence of action operators that lead from an initial planning state to a planning goal.

12. The computer-implemented method of claim 11, wherein the producing of the policy function and the probability distribution over options per the RL environment state is performed by using a reinforcement learning algorithm.

13. The computer-implemented method of claim 12, wherein the policy function comprises a set of option policy functions.

14. A computing device configured to integrate an Artificial Intelligence (AI) planner and a reinforcement learning (RL) agent through AI planning annotation in RL (PaRL), the device comprising:
a processor;
a memory coupled to the processor, the memory storing instructions to cause the processor to perform acts comprising:
identifying an RL problem;
receiving a description of a Markov decision process (MDP) having a plurality of states in an RL environment to generate an RL task to solve the RL problem;
receiving an AI planning model described in a planning language;
mapping state spaces from the plurality of MDP states in the RL environment to AI planning states of the AI planning model; and
annotating the RL task with an AI planning task from the mapping to generate a PaRL task.

15. The computing device according to claim 14, wherein the instructions cause the processor to perform an additional act comprising solving the identified RL problem using the generated PaRL task.

16. The computing device according to claim 15, wherein the instructions cause the processor to perform additional acts comprising:
generating one or more sets of AI plans in the options framework;
selecting options from the options framework for training the RL agent by ranking the options with scores; and
sending the options to the RL agent, wherein the selecting options from the options framework is performed offline.

17. The computing device according to claim 14, wherein the instructions cause the processor to perform additional acts comprising:
generating a plan given trajectory;
ranking options according to a scoring function; and
sending the options with a highest score to the RL agent.

18. The computing device according to claim 14, further comprising selecting the planning language from the group of a Planning Domain Definition Language (PDDL), a Stanford Research Institute Problem Solver (STRIPS), a Statistical Analysis Software (SAS+), and an Action Description Language (ADL).

19. The computing device according to claim 14, wherein the instructions cause the processor to perform additional acts comprising producing a policy function, and a probability distribution over RL environment actions per RL environment state by:
defining options for the RL environment based on the operators in the planning task;
defining an initiation set of an option by a set of states of the RL environment that is mapped by L to states satisfying the precondition of an action operator; and
defining the termination set of an option by the set of states of the RL environments that are mapped by L to states satisfying the effects of the action operator.

20. A non-transitory computer readable storage medium tangibly embodying a computer readable program code having computer readable instructions that, when executed, causes a computer device to carry out a method of integrating an Artificial Intelligence (AI) planner and a reinforcement learning (RL) agent through AI planning annotation in RL (PaRL), the method comprising:
identifying an RL problem;
receiving a description of a Markov decision process (MDP) having a plurality of states in an RL environment to generate an RL task to solve the RL problem;
receiving an AI planning model described in a planning language;
mapping state spaces from the MDP states in the RL environment to AI planning states of the AI planning model; and
annotating the RL task with an AI planning task from the mapping to generate a PaRL task.
